(19) United States
(12) Patent Application Publication
(10) Pub. No.: US 2012/0284604 A1
(43) Pub. Date: Nov. 8, 2012

(54) METHOD FOR CONFIGURING A GRAPHIC USER INTERFACE OF AN APPARATUS FOR PROCESSING VALUE DOCUMENTS

(76) Inventor: Peter Hocherl, Munchen (DE)

(21) Appl. No.: 13/521,075

(22) PCT Filed: Dec. 22, 2010
(86) PCT No.: PCT/EP10/07882

§ 371 Date: Jul. 9, 2012

(30) Foreign Application Priority Data
Jan. 8, 2010 (DE) 102010004166.1

(51) Int. Cl. G06F 17/00

(52) U.S. Cl. 715/224

(57) ABSTRACT

A device for processing value documents, includes a display device for displaying information relating to the processing and/or the value documents, and a control device, which actuates the display device, can optionally be operated in a configuration mode and a working mode, in which the device can process value documents, and includes a graphical user interface, by means of which at least one representation with an information field can be displayed on the display device at least in the operating mode and which provides an alphanumerical field and a graphical field for displaying the information field, and which in the configuration mode is designed to either establish the alphanumerical field or the graphical field for representing the information field in the working mode in response to a selection signal.

The present invention relates to a method for configuring a graphic user interface of an apparatus for processing value documents, in particular bank notes, by means of which, in a working mode of the apparatus, on a display device at least one representation is displayable with at least one information field, as well as an accordingly adapted apparatus for processing value documents.

Value documents for the purposes of the present invention are papers of value, e.g. shares, warrants, bonds or in particular bank notes, as well as identity documents, such as passports, personal identity cards, company identity cards, membership cards and identity cards, but also bank and credit cards, chip cards and magnetic strip cards. The apparatuses for processing such value documents can possess a great variety of functionalities and components, e.g. for sorting the value documents, for printing on the value documents, for destroying the value documents, for providing the value documents with one or several security features and for checking certain properties of the value documents, such as value, constitution, fitness for circulation, soiling, age and certain markings.

Such apparatuses for processing value documents often have a display device for displaying information items, for example an LCD display device, and a control device which drives at least this display device. To make the operation of the apparatus, for example the selection of a certain operation mode, as simple and intuitive as possible, such apparatuses often have a graphic user interface, by means of which representations are displayable on the display device. A graphic user interface is understood within the framework of the present invention to be program code and optionally present configuration data, upon the execution of which by a processor of the control device this control device drives the display device for displaying at least one predetermined representation. The representation then can have one or more information fields, in which information items for a user can be displayed. An information field is understood within the framework of the present invention to be a predetermined region of the representation or a predetermined region of the display device, in which predetermined information is only represented when the apparatus is used for processing value documents, or is in its working mode.

It should be possible that the representations, in particular also information fields, can be adjusted to different local languages or fonts. So that a desired representation can be actually displayed by means of the graphic user interface, this must be changed or adjusted, for example by changing the programming or reprogramming. But it is also possible to adjust for an existing code only parameters or configuration data, i.e. to configure the graphic user interface. In case of complicated font character sets, such as Chinese (several dialects must be taken into account), Korean, Japanese, (several character sets are to be taken into account) or Arabic, a corresponding change, however, becomes very elaborate, because the corresponding characters can be represented only in complicated fashion by alphanumeric characters. In particular, a change appears to be economically favorable only when for a language or font such a large number of apparatuses can be sold that a change of the user interface pays its way. This requirement, however, restricts the employment of apparatuses for processing value documents

The present invention is hence based on the object of providing a method with which a graphic user interface of an apparatus for processing value documents can be easily configured, as well as creating a corresponding apparatus.

The object is achieved, according to a first aspect, by a method for configuring a graphic user interface of an apparatus for processing value documents which has a display device on which, in a working mode of the apparatus in which it can process value documents, at least one representation is displayable with an information field by means of the graphic user interface. For displaying the at least one representation, the graphic user interface provides both an alphanumeric field and a graphic field, whereby in the method, in a configuration mode of the apparatus, in response to a selection signal, either the alphanumeric field or the graphic field is specified for representing the information field in the working mode.

The object is further achieved, according to the first aspect, by an apparatus for processing value documents with a display device for displaying information items with respect to the processing and/or the value documents, and a control device which drives the display device, is selectively operable in a configuration mode and a working mode in which the apparatus can process value documents, and has a graphic user interface by means of which on the display device, at least in the working mode, at least one representation is displayable with an information field and which for displaying the information field provides both an alphanumeric field and also a graphic field. The control device is constructed for specifying, in the configuration mode, in response to a selection signal, either the alphanumeric field or the graphic field for representing the information field in the working mode.

An apparatus for processing value documents is understood within the framework of the present invention to be in particular any apparatus by means of which value documents can be machine-checked with respect to predetermined criteria, for example authenticity and/or state, and/or value documents can be sorted and/or value documents can be accepted and/or issued and/or counted. For this purpose, the apparatus can have, besides the control device and the display device, at least a device for accepting value documents and/or a device for outputting value documents and/or a device for storing value documents, a transport device for transporting value documents in the apparatus as well as a sensor device for capturing predetermined physical properties of value documents to be processed with the apparatus. The sensor device can be constructed for checking predetermined criteria in which are included the properties captured by this sensor device, and outputting a signal representing the result of the check of the criterion, for example an authenticity criterion; however, it is, alternatively or additionally, also possible that the sensor device generates the signals representing the captured physical properties, which signals are employed in the control device for checking the predetermined criterion.

The control device, which is connected via a signal connection at least with the display device, preferably also with other parts of the apparatus, can in particular have a processor and a memory device. In the memory device there can be stored program code, optionally including parameter values which are employed upon the execution of the program code, and configuration data to be employed by the program code. The program code is executed at least partly by the processor upon the operation of the apparatus. In particular, it can comprise the graphic user interface, so that upon the execution of the code the display device is controlled accordingly.

An alphanumeric field of the graphic user interface is understood within the framework of the invention to be program code, optionally including parameter values with respect to details of the display, upon the execution of which by the processor, in a partial region, optionally predetermined by the parameter values, of the display device an information field is displayed which contains alphanumeric characters. The program code, for this purpose, accesses configuration data which represent character by character, for example in ASCII or ANSI code, the information which is to be represented at least as a sequence of alphanumeric characters.

A graphic field of the graphic user interface, on the other hand, is understood within the framework of the invention to be program code, optionally including parameter values with respect to details of the display, upon the execution of which by the processor, in a partial region, optionally predetermined by the parameter values, of the display device a graphic is displayed which is determined by graphic data which represent configuration data and which the program code accesses. Preferably, only a graphic determined by graphic data is displayed in the information field. The graphic data can comprise in particular data which define a vector graphic and/or a bitmap graphic, but not sequences or strings of alphanumeric characters to be represented individually.

The apparatus has at least one working mode in which it processes value documents; the apparatus is preferably constructed such that the apparatus can work in several working modes which may differ in the type of the processing or the type of the processed value documents, or that the working mode has several sub-modes which may differ in the type of the processing or the type of the processed value documents. In the working mode, in particular also, if present, in at least one of the sub-modes, there is displayed a predetermined representation which has the at least one information field. The representation is associated with the working mode or, if given, optionally with a sub-mode of the working mode. In the working mode of the apparatus, the control device employs for displaying the at least one information field, in the otherwise identical representation, either the alphanumeric field or the graphic field. The fields are preferably determined such that the information field, displayed by these fields, is displayed in the otherwise identical representation, i.e. in the same working mode or in the same sub-mode of the working mode at the same place of the representation or of the display device and with the same size.

Which of the two fields, the alphanumeric or the graphic, is employed in the working mode, is specified in the configuration mode in which the graphic user interface at least partly and preferably also the apparatus is configurable. In this, in response to a selection signal, which is generated preferably by an operating element of the apparatus or an operating element connected to the apparatus after or upon the actuation of the operating element by a user of the apparatus and represents which one of the fields is to be employed, the field to be employed is specified. In particular, for this purpose, in response to the signal there can be set and stored a parameter value which describes the selection and is employed upon the execution of the program code in the working mode.

In this way it is possible to configure the graphic user interface without subsequent programming and, in particular also to easily adjust a display for use in countries in which a representation of information items via entering alphanumeric characters is difficult or complicated.

Basically, the graphic data can be provided in any fashion. Preferably, however, in the configuration mode there is activated, preferably by a signal triggered by a user, a drawing mode in which by means of a pointing device there are generated and stored graphic data which specify a graphic representable by means of the graphic field. For this purpose, in the apparatus, preferably the control device can have an interface for a pointing device and be constructed such that it captures, at least in the configuration mode, in response to signals of a pointing device connected via the interface with the control device, positions on the display device given through the signals, and that preferably the control device, in the configuration mode, can be put into a drawing mode in which, in response to signals of the pointing device, graphic data are generatable and storable which specify a graphic representable by means of the graphic field. The graphic data in this respect are configuration data. A pointing device here is understood to be an input device, by means of which a pointer represented in a representation on the display device of the apparatus can be moved and/or a position in the representation on the display device can be selected. For example, this can be a mouse, a touch pad, a touch-sensitive display device, e.g. a touch screen, or a trackball or the like. This embodiment offers the great advantage that a user can configure the graphic user interface even without an external memory device or an external computer.

The pointing device here needs to be connectable with the apparatus only temporarily for configuration, such as this may be the case for example with an external mouse. Particularly preferably, the pointing device connected with the interface, however, can be part of the apparatus, i.e. can be connected therewith not only for the purposes of configuration, but also for use in the working mode, and/or be held in or at a housing of the apparatus. In the method, too, the pointing device can be, preferably within this meaning, part of the apparatus.

A simple configuration of the user interface is even possible when no alphanumeric field is present.

The object is hence also achieved, according to a second aspect, by a method for configuring a graphic user interface of an apparatus for processing value documents which has a display device on which, in a working mode of the apparatus in which it can process value documents, at least one representation is displayable with an information field by means of the graphic user interface, whereby, in the method, in a configuration mode of the apparatus, there is activated, preferably by a signal triggered by a user, a drawing mode in which by means of a pointing device there are generated and stored graphic data which specify a graphic representable in the information field by means of a graphic field of the operating surface.

The object is further achieved, according to the second aspect, by an apparatus for processing value documents with a display device for displaying information items with respect to the processing and/or the value documents, a pointing device, and a control device connected with the display device and the pointing device, which drives the display device, is selectively operable in a configuration mode and a working mode in which the apparatus processes value documents, has a graphic user interface which provides for a partial region of the representation at least one graphic field, and is constructed such that it captures, at least in the configuration mode, in response to signals of the pointing device, a position on the display device given through the signals, and that, in the configuration mode, it can be put into a drawing mode, in which by means of the pointing device data are capturable and storable which specify a graphic representable in the graphic field.

Unless reference is made to the alphanumeric field, the previous statements regarding the first aspect preferably also apply to the second aspect.

The following preferred embodiments and developments are advantageous for both aspects of the invention.

The graphic data can in principle be present in any form. For example, the graphic data may comprise data for a vector graphic. For this purpose, the control device can be constructed such that, as graphic data, data are generatable which comprise data for a bitmap graphic. This embodiment has the advantage that the graphic data require only little memory space and in particular geometrical shapes can be easily generated and stored.

Alternatively or additionally, the graphic data can comprise preferably data for a bitmap graphic. For this purpose, the control device can be constructed such that, as graphic data, data are generatable which comprise data for a bitmap graphic. In a bitmap graphic, the picture is described with the help of a grid of dots with different color or grayscale values. The bitmap graphic can be stored in any form, uncompressed or compressed, for example in the tif or jpeg format. This embodiment offers the advantage, that graphic data can be easily generated even for complicated graphics, i.e. graphics not constructed of simple geometric elements.

Preferably, for capturing the graphic data, positions determined by signals of the pointing device can be displayed on the display device and the graphic data be generated in dependence on the signals of the pointing device. For this purpose, the control device can be accordingly constructed. This makes possible a comfortable input of the graphic data. In particular, the control device can be constructed such that in the drawing mode there are activatable, in dependence on signals of the pointing device, a function for capturing graphic data for dots and/or lines and a function for deleting graphic data for dots and/or lines, for example by signals triggered by a user. This embodiment offers the advantage that a user can generate graphic data as with a writing device. In particular, in the drawing mode there can be provided drawing elements such as circles, straight lines, etc. to select from, the exact position, design, etc. of which is defined by signals of the pointing device which the user operates.

As already stated, the pointing device can be constructed in any fashion. Preferably, however, as pointing device and display device, a touch-sensitive display device is employed, and during the generation of the graphic data for the graphic on the display device, a part of the graphic specified through the already captured graphic data is displayed. For this purpose, in the apparatus, the pointing device and the display device together can be formed by a touch-sensitive display. This embodiment offers the advantage that the touch-sensitive display, for example a touch screen, can be employed also in the working mode for operation. Moreover, a user can generate graphic data by manual drawing in the drawing mode. If graphic data are generated which merely reproduce the position data captured by the pointing device, these can in particular be quasi painted on the touch-sensitive display, i.e. the user sees, directly after touching the touch-sensitive display at some place, for example a blackening at this place as a component of the generated graphic.

The information field can in principle serve to display any predetermined information items. In particular, the graphic user interface can be configured such that the information field, in the working mode of the apparatus, displays information with respect to value documents to be processed or processed with the apparatus and/or with respect to the processing of the value documents and/or displays a setting of the apparatus, selectable by the user, with respect to value documents to be processed or processed with the apparatus and/or with respect to the processing of the value documents. In the apparatus, the graphic user interface can preferably be adapted to display, in the working mode of the apparatus, by means of the information field information items with respect to value documents to be processed or processed with the apparatus and/or with respect to the processing of the value documents and/or to display settings of the apparatus, selectable by the user, with respect to value documents to be processed or processed with the apparatus and/or with respect to the processing of the value documents.

In particular, the configuration of the operating surface according to at least one of the two aspects of the invention requires less system knowledge, since a complicated text input can be omitted. This means that the information fields can be adjusted to the respective local languages by staff not specially trained therefor, for example by distribution companies. This is of great importance in particular with low-price machines with small touch-screens. Additionally, the graphic represented in the information field by means of the graphic field opens up much more design possibilities than a simple ASCII text. In particular, through the use of information fields with intuitive graphics, which not necessarily have to reproduce a text (for instance pictograms), the operating surface can be configured particularly user-friendly. Furthermore, the development of software for inputting complex languages can be omitted. A software required (only according to the second aspect of the invention) for implementing the drawing mode is substantially less elaborate than a software for inputting complex characters. Instead of implementing a possibility of selecting several hundred characters, it may e.g. be sufficient to implement 3 pen widths and 3 eraser widths for the drawing mode.

The activation of the drawing mode is preferably effected based on a user input or is effected automatically based on a pre-defined condition. In the drawing mode, graphic data can be generated, which only reproduce position data captured by the pointing device. Alternatively or additionally, there can also be provided drawing elements such as circles, straight lines, etc. to select from, the exact position, design, etc. of which is defined with the pointing device. This embodiment is suitable in particular for capturing graphic data for vector graphics.

In the following the invention is still further explained by way of example with reference to the Figures. There are shown:

FIG. 1 schematically an apparatus for processing value documents with a configuration device for configuring a graphic user interface of the apparatus,

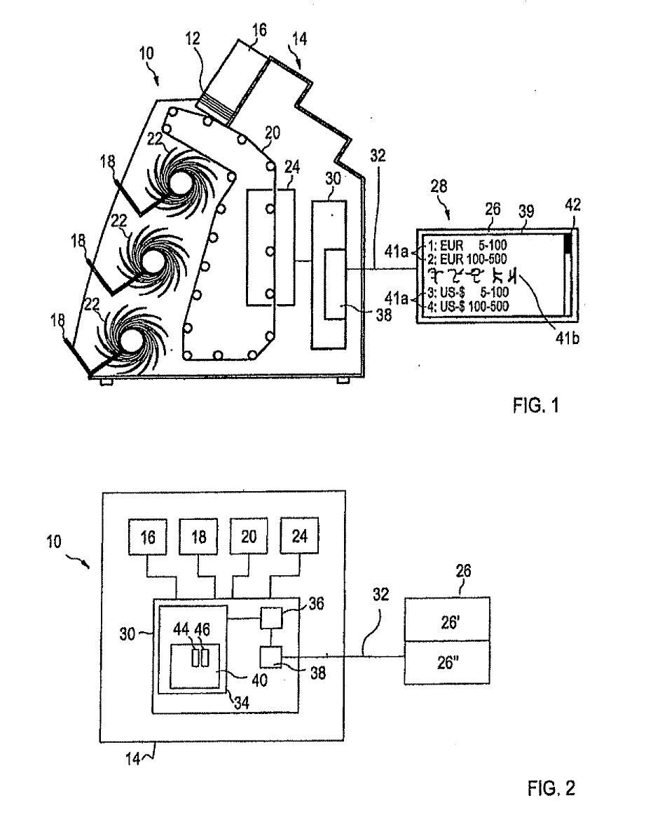

FIG. 2 schematically a block diagram of the apparatus in FIG. 1,

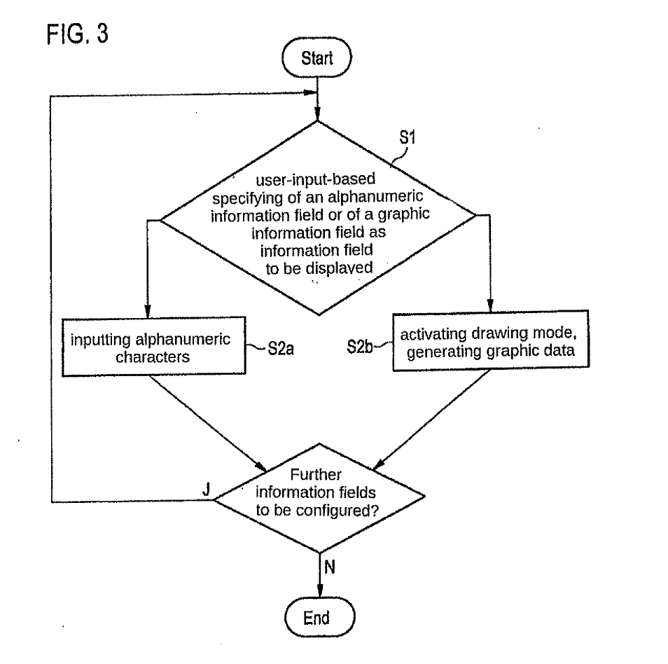

FIG. 3 schematically the steps of a method for configuring the graphic user interface of the apparatus in FIG. 1,

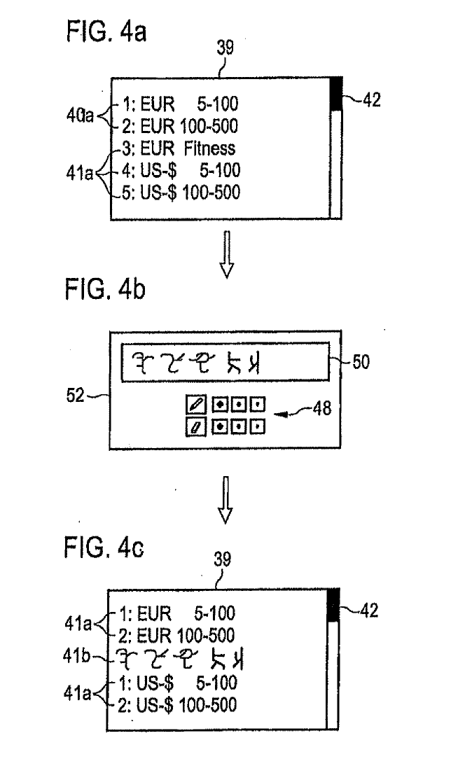

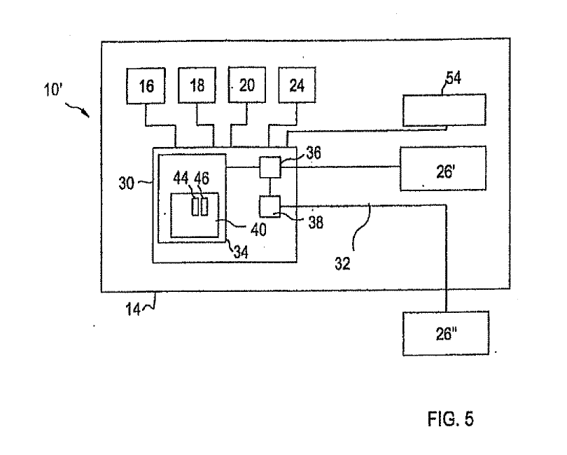

FIGS. 4a to 4c schematically with the help of a concrete example how an operating surface is configured according to the method explained with the help of FIG. 3, and

FIG. 5 schematically a block diagram of a further apparatus for processing documents of value,

FIGS. 1 and 2 show schematically an apparatus 10 for processing value documents 12, in the example bank notes. The processing comprises in the present example the checking and/or sorting of value documents. The apparatus 10 comprises in a housing 14 an input pocket 16 for inserting value documents, several, in the example three, output devices 18 for receiving processed value documents and a transport device 20 for the singled transport of value documents from the input pocket 16 to the output devices 18. For storing the value documents in the output devices 18, in the example, stacking wheels 22 are provided. The transport device 20 has, at the beginning of the transport path formed by this transport device, i.e. at the input pocket 16, a singler, not shown in the Figures, for singling value documents 12 which are located as a stack in the input pocket 16. For checking the value documents, at the transport path given by the transport device 20 there is arranged a sensor device 24 which serves for checking the value documents which are transported past or through this sensor device in singled fashion. In particular, it is constructed for capturing predetermined physical properties of the value documents and checking at least one predetermined criterion for the respective value document, in which criterion at least some of the captured properties are included, i.e. are employed upon the check. In dependence on the result of the check, it emits a signal representing the result of the check.

The apparatus further has a touch-sensitive display device 26 (touch screen) which acts as a combination of display device 26′ and pointing device 26″ and by means of which the value document processing apparatus 10 can be operated by a user. In this example, the touch-sensitive display device 26 is provided in an operating terminal 28 arranged outside the housing.

For driving the display device 26′ and the pointing device 26″ or the touch-sensitive display device 26 as well as for driving the sensor device 24 and the transport device 20 as well as, possibly, further optional components of the apparatus 10 and for processing signals of the pointing device 26″ and in this embodiment of the sensor device 24 and of the transport device 20 there is provided a control device 30 which is connected via signal connections 32 with the mentioned devices. The control device 30 has a memory 34 for storing program code including data or parameter values necessary for executing the program code and for storing configuration data, and a processor 36 for executing at least parts of the stored program code, and interfaces for the devices connected with the control device, in particular an interface 38 for the pointing device 26″, which partly can be given by program code in the memory 34.

The program code stored in the memory 34 comprises a graphic user interface 40. Upon the execution of the program code of the graphic user interface 40, the processor drives the display device 26′ in such a way that thereupon representations determined by the program code, the configuration data and, optionally, the operating state of the apparatus are displayed. Simultaneously, the processor captures, in dependence on signals of the pointing device 26″, a respective position on the display device 26′ or of the representation displayed thereon. The position can be changed by a user by means of the pointing device 26″; in this embodiment the positioning is effected by touching the touch-sensitive display device in its touch-sensitive region, whereby the pointing device 26″ generates corresponding signals and emits them to the control device 30, in particular the interface 38 which evaluates them.

The control device 30 is constructed such that the apparatus 10 is operable in at least two operating modes. On the one hand, at least one working mode is provided in which the apparatus processes value documents. This working mode has at least two different sub-modes which differ from each other in the type of the processing of the value documents. On the other hand, a configuration mode is provided in which, inter alia, the function of the apparatus in the at least two sub-modes of the working mode is configurable.

The apparatus is constructed such that in the working mode it can sort value documents. In principle, the sorting can be effected according to any properties of the value documents, such as for example value, constitution, fitness for circulation, soiling, age or certain markings. In the example, a sorting according to value can be effected.

In the working mode, in particular also its sub-modes, the control device 30 displays representations by driving the display device 26′ by means of the graphic user interface. In FIG. 1 there is shown by way of example a representation 39 which has information fields 41a, 41b indicated by dashed lines in the Figures. These information fields are for example partial regions, predetermined by parameters, of the representation or on the display device 26′, in which respectively a predetermined information is represented. The number and type of the information fields can be the same or different for each of the sub-modes. Via these representations, a user can specify, in the working mode of the apparatus 10, settings of the apparatus 10 with respect to value documents to be processed or processed with the apparatus 10 and/or with respect to the processing of the value documents. In the shown embodiment the representation has five information fields 41a, 41b. In the present embodiment it is in particular designed as a menu with several entries in the form of the information fields 16a, 16b and a scroll bar 42. The information fields 16a, 16b mark in the present case certain selectable functionalities of the apparatus 10, such as e.g. sub-modes. For example, a bank note processing machine may not have the two, but 50 different configurable sub-modes. A user then selects, in the working mode, from the predetermined representation, i.e. the menu with several entries in the form of information fields 41a, 41b, a special sub-mode in which thereupon the apparatus is operated. The five displayed information fields 41a, 41b normally represent only a partial region of the displayed representation, in special cases, however, also already one displayed information field can constitute the entire displayed operating surface.

In principle, with such information fields 41a, 41b any information items can be represented or conveyed. In particular, with such information fields 41a, 41b there can be displayed settings of the apparatus 10, selectable by the user, with respect to value documents to be processed or processed with the apparatus 10 and/or with respect to the processing of the value documents. Alternatively or additionally, with such information fields 41a, 41b there can also be displayed information items with respect to value documents to be processed or processed with the apparatus 10 and/or with respect to the processing of the value documents.

The graphic user interface 40 has, for representing at least one of the information fields 41b in the predetermined representation, an alphanumeric field 44 and a graphic field 46, which in the respective mode are displayed respectively at substantially the same place of the representation and preferably with substantially the same size. The alphanumeric field receives as input data for example a character string which is represented in the information field. The graphic field, on the other hand, receives as input data graphic data which are represented in the information field. In the working mode or in at least a sub-mode of the working mode, the control device 30 employs for representing the information field, depending on the configuration of the graphic user interface, either the alphanumeric field or the graphic field.

The control device 30 is constructed such that in the configuration mode, in response to a selection signal, it specifies which of the two fields is employed for representing the information field. This can be done in particular by the control device storing, in dependence on the selection signal, configuration data that represent which of the fields is to be employed in the working mode for displaying the information field.

For operating the device in the configuration mode there serves in the example the control device 30 in connection with the display device 26′ and the pointing device 26″, i.e. in the example the touch-sensitive display 26 as well as the graphic user interface 40. For example, the graphic user interface can be programmed such that in the configuration mode it displays for the at least one information field 41b two fields, one of which can be selected by means of the pointing device 26″, in the example by touching the touch-sensitive display device 26 in the region of the respective field. Depending on the selection signal triggered by the touching, then the configuration data predetermined by the field are stored.

When the alphanumeric field is selected, as input data for the field there can be employed data that are already stored and represent an alphanumeric character string. The control device 30 is preferably constructed such that in the configuration mode these input data can also be changed or newly captured by means of the control device 30.

When the graphic field is selected, the control device employs, upon the displaying in the working mode by means of the graphic field, as input data for this graphic field graphic data which can be generated by means of the control device 30, the display device 26′ and the pointing device 26″ or in the present example the touch-sensitive display device 26. In the present example, as graphic data bitmap data are employed.

In the present embodiment, the bitmap data are generated by means of the apparatus itself For this purpose, the control device 30, in particular the program code, is adapted such that in the configuration mode a drawing mode is activatable, in which by means of a pointing device, in the example the pointing device 26″, there are generated and stored graphic data which specify a graphic representable in the information field by means of a graphic field of the operating surface.

In FIG. 3 there are schematically shown steps of a method executed by the control device 30 upon executing program code in the memory of the control device for configuring the graphic user interface 40 of the apparatus 10.

First, the control device 30 checks in an optional step, not shown in FIG. 3, by querying a user identification and a password by means of the touch-sensitive display device 26, whether the user is authorized to use the apparatus in the configuration mode. Only in this case, the following method steps are executed.

In the first actual method step S1 of the method the control device drives the display device 26′ to display a representation in which the user can select by means of a pointing device either an alphanumeric field or a graphic field for representing at least one of the predetermined information fields. By the user operating the pointing device 26″, this pointing device generates a selection signal that represents which of the two fields is to be employed. The control device 30 specifies, in response to the selection signal, by storing corresponding configuration data which in the working mode are employed by the graphic user interface and in dependence of which either the alphanumeric or graphic field is employed, which of the fields is to be used in the working mode.

If an alphanumeric field has been specified for displaying the information field, the control device 30, in method step S2a, changes into a text input mode, in which the user is prompted to input via the touch-sensitive display 26 a character string of alphanumeric characters (e.g. a text) to be displayed in the information field. If, subsequently, further information fields to be displayed are to be configured, the method begins anew with the above-described method step S1, otherwise the method ends.

If, however, in the first method step S1, a graphic field has been selected or specified for representing the information field to be displayed, after the method step S1 there follows the method step S2b in which a drawing mode is activated, i.e. the control device 30 changes into the drawing mode. In the drawing mode then, as input data for the graphic field, graphic data defining a graphic to be displayed in the information field are generated by means of a pointing device, for example via the touch-sensitive display 12, and stored in a memory of the control device 30.

In the drawing mode there can be generated graphic data which merely reproduce position data given by means of the pointing device 26′, in the example the touch-sensitive display 26. As can be seen in FIG. 4b, the control device 30 provides for this purpose selection elements 48 in a drawing menu, by means of which a pin and various stroke widths for the pin as well as an eraser and various diameters of the eraser can be activated by corresponding inputs of the user and then be used. Upon selection of a pen, pixels can be marked as colored or black. The control device 30 is adapted to drive the display device 26′ such that it displays already generated graphic data or corresponding, already generated parts of the graphic during the generating. If graphic data are generated which merely reproduce the position data captured by the pointing device, these can then be painted quasi on the display device 26′. That means, when the touch-sensitive display 26 serves as the pointing device 26′, the user sees, directly after touching the touch-sensitive display 26 at some place, for example a blackening at this place as a component of the generated graphic. The control device stores the generated graphic data as configuration data or data for a bitmap graphic, for example in the tif format.

If, subsequently, further information fields to be displayed are to be configured, the method begins anew with the above-described method step S1, otherwise the method ends.

In the FIGS. 4a to 4c there is schematically illustrated with the help of a concrete example, how the graphic user interface 40 is configured according to the method explained above with the help of FIG. 3. FIG. 4a shows a representation 39, displayed by means of the graphic user interface, in the form of a selection menu to be displayed in the working mode with several entries in the form of information fields 41a, 41b with alphanumeric characters. Such a representation is displayed in the working mode of the apparatus 10 on the display device 26′ of the apparatus 10, whereby by means of a pointing device 26″, in particular the touch-sensitive display 26, at least one of the information fields 41a, 41b can be selected, in order to select at least one sub-mode of the working mode defined before in the configuration mode of the apparatus 10.

In the present example, in the configuration mode, the third entry, i.e. the third information field 41b of the menu, is to be adjusted to a specific local language. As the characters of this local language can be input only with difficulties by means of an alphanumeric keyboard, it is specified, as described above, that for displaying the third information field 41b instead of the previous alphanumeric field 44 now a graphic field 46 is to be used (method step S1 in FIG. 3).

Thereafter, a drawing mode is automatically activated, in which an operating surface of a drawing software is displayed on the display device 26′ (method step S2bin FIG. 3). Therewith, a pin or an eraser with three different widths can be selected by means of the selection fields 48. With these tools, then a graphic is drawn with the pointing device in the field 50 (method step S2b in FIG. 3). After the drawing of the graphic has been finished, the drawing mode is terminated and the finished graphic is stored as configuration or input data for the graphic field for representing the information field 41b.

In FIG. 4c, there is represented the final selection menu with the information field 41b drawn before as the third entry.

Generally, it is not necessary that the above-mentioned steps S1 and S2a or S2b are combined. Thus, further embodiments may differ from the preceding embodiment in that in the information field also previously stored graphics or texts are displayed, by means of which the inputting of the graphic to be displayed or the text to be displayed is omitted. This is possible in particular with permanently stored texts and graphics, which need not to be constantly changed.

A further embodiment hence differs from the first embodiment in that the control device is changed to the effect that the graphic user interface provides only a graphic field, but not an alphanumeric field to be displayed at the same place, for representing the information field in the working mode. It this method it is then only necessary to define in the drawing mode the graphic of the graphic information field 41b.

Further embodiments differ from the preceding embodiments in that the display device 26′ and the pointing device 26″ are not given by the touch-sensitive display device 26. Such an embodiment for an apparatus 10′ is shown in FIG. 5. The display device 26′ is given by an LCD display device, which is installed in the housing of the apparatus 10′, and the pointing device 26″ by an external mouse, optionally to be employed only for configuration, or another pointing device. The control device 30 is accordingly changed compared to the control device of the preceding embodiments, in particular the interface for the pointing device and the graphic user interface 40 is accordingly modified. Besides, there can be provided, as a further input device 54, a keyboard connected via a signal connection with the control device, by means of which the control device can capture signals representing alphanumeric characters. In particular, the control device is constructed to drive the display device 26′ such that a position specified by the pointing device 26″ is displayed by a pointer, i.e. symbol displayed at a corresponding position in a representation on the display device 26′, on the display device 26′. The other devices are unchanged, so that the same reference signs are employed for them as in the first embodiment and the explanations thereon apply accordingly here as well.

Activating the drawing mode in the method step S2b and the text input mode in the method step S2a, in the first embodiment, is effected automatically, as soon as in the method step S1 an alphanumeric field or a graphic field for representing the information field 41b has been selected. In principle, in other embodiments the drawing mode and/or the text input mode can also be activated selectively by activation signal that is generated by a further user input and fed to the control device 30. Additionally or alternatively, by a user input there can also be started e.g. a mode for selecting a predefined graphic or predefined graphic data or a predefined text or a predefined character string.

A further embodiment may differ from the preceding embodiments in that the control device 30 is constructed to additionally provide, in the drawing mode, drawing elements for circles, straight lines etc to select from, the exact position, design etc of which can be defined by means of the pointing device.

A still further embodiment differs from the preceding embodiments in that the control device 30 is adapted such that as graphic data not bitmap data but data for a vector graphic can be generated and stored.

However, it is also possible that the control device is constructed such that, as graphic data, it generates and stores both bitmap and vector graphic data, and later uses these as input or configuration data for the graphic field.

Furthermore, information fields 41b are conceivable, which comprise both alphanumeric characters (input, not drawn) and graphic data. For example, as drawing elements there can also be provided alphanumeric letters to select from, whereby preferably the exact position, design etc of which are defined with the pointing device. Alternatively or additionally, there can also be provided drawing elements such as circles, straight lines etc to select from, the exact position, design, etc. of which is defined with the pointing device.

As already partly described, the represented method need not be related only to information fields 41a, 41b which are displayed by the operating surface in any case in the working mode of the device, i.e. also in all the sub-modes thereof, but in particular also to information fields 41a, 41b which are displayed only under certain, predetermined conditions in the working mode, in particular in only a part of the sub-modes of the working mode.

Further embodiments may differ from the above-described embodiments in that they are constructed such that the processing of value documents can comprise a printing on value documents, an application of security features onto value documents or a destruction of value documents.

Other embodiments may differ from the preceding embodiment in that the value document processing apparatus can be constructed for processing value documents such as shares, warrants, bonds and the like, identity documents such as passports, personal identity cards, company identity cards, membership cards and identity cards, bank and credit cards, chip cards and magnetic strip cards as well as any other value documents. The apparatus can then be accordingly adjusted to the type of the value documents to be processed.

1.-17. (canceled)

18. A method for configuring a graphic user interface of an apparatus for processing value documents which has a display device which, in a working mode of the apparatus, is operable to process value documents by the graphic user interface and on which at least one representation is displayable with an information field, for the display of which the graphic user interface provides both an alphanumeric field and a graphic field, comprising:
in a configuration mode of the apparatus, in response to a selection signal, specifying either the alphanumeric field or the graphic field for representing the information field in the working mode.

19. The method according to claim 18, including activating by a signal triggered by a user in the configuration mode, a drawing mode in which, by using a pointing device, there are generated and stored graphic data which specify a graphic representable by of the graphic field.

20. A method for configuring a graphic user interface of an apparatus for processing value documents which has a display device on which, in a working mode of the apparatus in which processing of value documents is enabled, by means of the graphic user interface at least one representation is displayable with an information field, comprising: in a configuration mode of the apparatus, activating by a signal triggered by a user, a drawing mode in which by a pointing device there are generated and stored graphic data which specify a graphic representable in the information field by a graphic field of the operating surface.

21. The method according to claim 19, wherein the graphic data comprise data for a vector graphic.

22. The method according to claim 19, wherein the graphic data comprise data for a bitmap graphic.

23. The method according to claim 19, wherein, for capturing the graphic data, positions determined by signals of the pointing device are displayed on the display device, and the graphic data are generated in dependence on the signals of the pointing device.

24. The method according to claim 19, wherein, as pointing device and display device, using a touch-sensitive display device, and during the generation of the graphic data for the graphic on the display device, displaying a part of the graphic specified through the already captured graphic data.

25. The method according to claim 18, wherein the graphic user interface is configured such that the information field in the working mode of the apparatus:
displays information with respect to value documents to be processed or processed with the apparatus and/or with respect to the processing of the value documents and/or
displays a setting of the apparatus, selectable by the user, with respect to value documents to be processed or processed with at least one of the apparatus and with respect to the processing of the value documents.

26. An apparatus for processing value documents comprising:
a display device displaying information items with respect to at least one of the processing and the value documents, and
a control device which drives the display device, is selectively operable in a configuration mode and a working mode in which the apparatus processes value documents, and has a graphic user interface by means of which on the display device, at least in the working mode, at least one representation is displayable with an information field, and which for displaying the information field provides an alphanumeric field and a graphic field, and which is configured to specify, in the configuration mode, in response to a selection signal, either the alphanumeric field or the graphic field for representing the information field in the working mode.

27. The apparatus according to claim 26, wherein the control device comprises an interface for a pointing device and is configured such that it captures, at least in the configuration mode, in response to signals of a pointing device connected with the control device via the interface, positions on the display device given through the signals, and wherein the control device, in the configuration mode, is operable in a drawing mode in which, in response to signals of the pointing device, graphic data are generatable and storable which specify a graphic representable by the graphic field.

28. The apparatus according to claim 27, comprising the pointing device connected with the interface.

29. An apparatus for processing value documents comprising:
a display device displaying information items with respect to at least one of the processing and the value documents,
a pointing device, and
a control device connected with the display device and the pointing device, which drives the display device, is selectively operable in a configuration mode and a working mode in which the apparatus processes value documents, comprises a graphic user interface which provides for a partial region of the representation at least one graphic field, and is arranged such that it captures, at least in the configuration mode, in response to signals of the pointing device, a position on the display device given through the signals, and, in the configuration mode, is operable in a drawing mode, in which by means of the pointing device data are capturable and storable which specify a graphic representable in the graphic field.

30. The apparatus according to claim 26, wherein the control device is arranged such that, as graphic data, data are generatable which comprise data for a vector graphic.

31. The apparatus according to claim 26, wherein the control device is arranged such that, as graphic data, data are generatable which comprise data for a bitmap graphic.

32. The apparatus according to claim 27, wherein the control device is arranged such that in the drawing mode there is activatable, in dependence on signals of the pointing device, a function for capturing at least one of graphic data for dots and lines and a function for deleting graphic data for at least one of dots and lines.

33. The apparatus according to claim 26, wherein the pointing device and the display device comprise a touch-sensitive display.

34. The apparatus according to claim 26, wherein the graphic user interface is configured, in the working mode of the apparatus, by the information field to, at least one of:
display information items with respect to value documents to be processed or at least one of processed with the apparatus and with respect to the processing of the value documents; and
display settings of the apparatus, selectable by the user, with respect to value documents to be processed or processed with at least one of the apparatus and with respect to the processing of the value documents.
